(19) United States
(12) Patent Application Publication
(10) Pub. No.: US 2011/0107576 A1
(43) Pub. Date: May 12, 2011

(54) APPARATUS FOR AND METHOD OF ELEVATOR GUIDE POST REFURBISHMENT

(76) Inventors: Robert Garwood Lamond, Azilda (CA); Ryan Walter Siggelkow, Dowling (CA)

(21) Appl. No.: 12/940,165

(22) Filed: Nov. 5, 2010

Related U.S. Application Data
(60) Provisional application No. 61/258,620, filed on Nov. 6, 2009.

(51) Int. Cl. B23P 6/00; B26D 5/00

(52) U.S. Cl. 29/402.01; 83/745

(57) ABSTRACT

An apparatus for refurbishing an elevator guide post includes at least one cutting mechanism configured to remove material along a side face of the guide post to expose a new side face. Material can be removed from two side faces of the guide post new side faces on generally opposing sides of the guide post. Replacement boards can be installed onto the new side faces so that desired dimensions of the guide post are formed.

### CROSS-REFERENCE TO RELATED APPLICATION

This application claims priority to U.S. Provisional Application No. 61/258,620 filed on Nov. 6, 2009 and entitled APPARATUS FOR AND METHOD OF ELEVATOR GUIDE POST REFURBISHMENT, the entire contents of which are hereby incorporated herein by reference.

### FIELD

This specification relates to elevator guide posts typically found in a mine shaft.

### BACKGROUND

The following paragraphs are not an admission that anything discussed in them is prior art or part of the knowledge of persons skilled in the art.

An elevator typically found in a mine shaft includes a car that is raised and lowered by motor-driven cables attached to the top of the car at one end of the cables. The cables can travel around a pair of sheaves and attach to a counterweight, skip and/or cage at the other end of the cables. Guide posts can run the length of the shaft and serve to provide a desired path of travel and prevent the car from swaying or twisting. The guide posts are typically made of wood. Rollers can be attached to the car to provide smooth travel along the guide posts.

The elevator car can be provided with an emergency braking mechanism to arrest movement of the car. Cam-shaped dogs or other engaging members can be implemented to engage the guide posts if emergency braking is desired, for example, if the cables break or otherwise becomes slack. Movement of the rollers along the guide posts can cause the guide posts to become worn over time, and thereby introduce substantial and undesirable play between the guide posts and the car.

### INTRODUCTION

In an aspect of this specification, an apparatus for refurbishing a guide post, the guide post extending in a longitudinal direction and including a first side face and an outer face, can comprise: a frame; a plurality of wheels mounted to the frame and configured to rollably support the apparatus along the guide post; and a first cutting mechanism mounted to the frame and configured to produce a cut in the guide post along the outer face substantially in the longitudinal direction and substantially parallel to and adjacent the first side face.

In an aspect of this specification, a method of refurbishing a guide post, the guide post extending in a longitudinal direction and including a first side face and an outer face, can comprise: producing a first cut in the guide post along the outer face substantially in the longitudinal direction and substantially parallel to and adjacent the first side face; removing material of the guide post between the first cut and the first side face to expose a new first side face; and installing at least one replacement board onto the new first side face, the at least one replacement board being sized and shaped so that desired dimensions of the guide post are formed.

In an aspect of this specification, an apparatus for refurbishing a guide post, the guide post extending in longitudinal direction and including side faces and an outer face, can comprise: a frame; a guide device mounted to the frame and configured to guide the apparatus along the guide post and enable the apparatus to travel along the guide post; and a cutting mechanism mounted to the frame and configured to remove material from at least one of the side faces to expose at least one new side face, thereby to enable at least one replacement board to be attached to the at least one new side face.

In an aspect of this specification, a method of refurbishing a guide post, the guide post extending in a longitudinal direction and including side faces and an outer face, can comprise: removing material from the guide post along at least one of the side faces to expose at least one new side face; and installing at least one replacement board to the at least one new side face, the at least one replacement board being sized and shaped so that desired dimensions of the guide post are formed.

Other aspects and features of the teachings disclosed herein will become apparent, to those ordinarily skilled in the art, upon review of the following description of the specific examples of the specification.

### DRAWINGS

The drawings included herewith are for illustrating various examples of articles, methods, and apparatuses of the present specification and are not intended to limit the scope of what is taught in any way. In the drawings:

FIG. 1 is a perspective view of an apparatus positioned on a guide post;

FIG. 2 is a side view of the apparatus of FIG. 1 positioned on the guide post;

FIG. 3 is a top view of the apparatus of FIG. 1 positioned on the guide post;

FIG. 4 is a detailed top view of the apparatus of FIG. 1 positioned on the guide post;

FIG. 5 is a detailed perspective view of the apparatus of FIG. 1 positioned on the guide post;

FIGS. 6A, 6B and 6C are sectional views of a guide post being refurbished;

FIGS. 7A and 7B are side and top views of two apparatuses in a mine shaft;

FIGS. 8A and 8B are side and top views of four apparatuses in a mine shaft;

FIG. 9 is a front view of two apparatuses fitted with covers and vacuum hoses;

FIG. 10 is a perspective view of another apparatus positioned on a guide post, in which the apparatus is shown in a retracted position;

FIG. 11 is a perspective view of the apparatus of FIG. 10 positioned on the guide post, in which the apparatus is shown in an engaged position; and

FIG. 12 is a partial perspective view of the apparatus of FIG. 10 positioned on the guide post.

### DESCRIPTION OF VARIOUS EMBODIMENTS

Various apparatuses or processes will be described below to provide an example of an embodiment of each claimed invention. No embodiment described below limits any claimed invention and any claimed invention may cover processes or apparatuses that are not described below. The claimed inventions are not limited to apparatuses or processes having all of the features of any one apparatus or process described below or to features common to multiple or all of the apparatuses described below. It is possible that an apparatus or process described below is not an embodiment of any claimed invention. The applicants, inventors or owners reserve all rights that they may have in any invention disclosed in an apparatus or process described below that is not claimed in this document, for example the right to claim such an invention in a continuing application and do not intend to abandon, disclaim or dedicate to the public any such invention by its disclosure in this document.

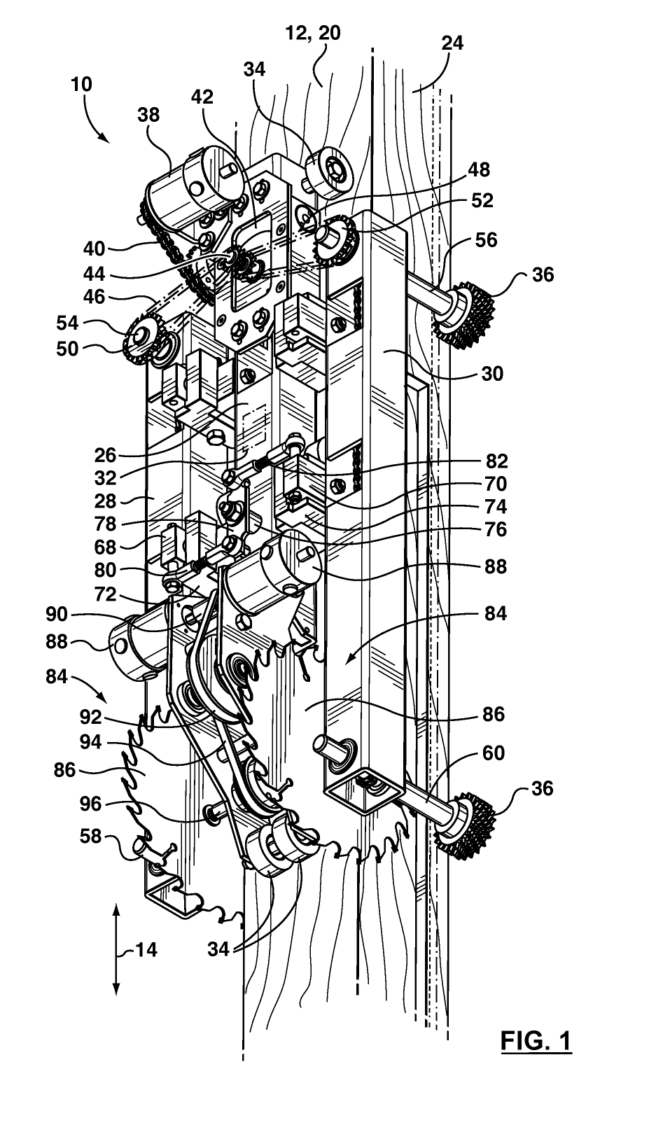

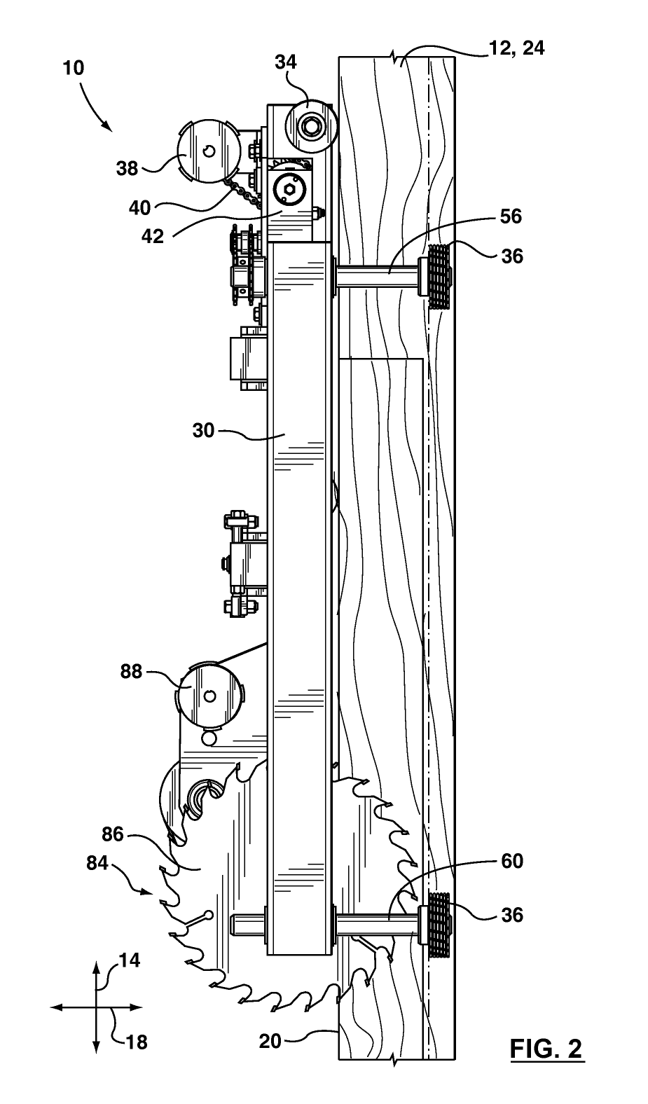

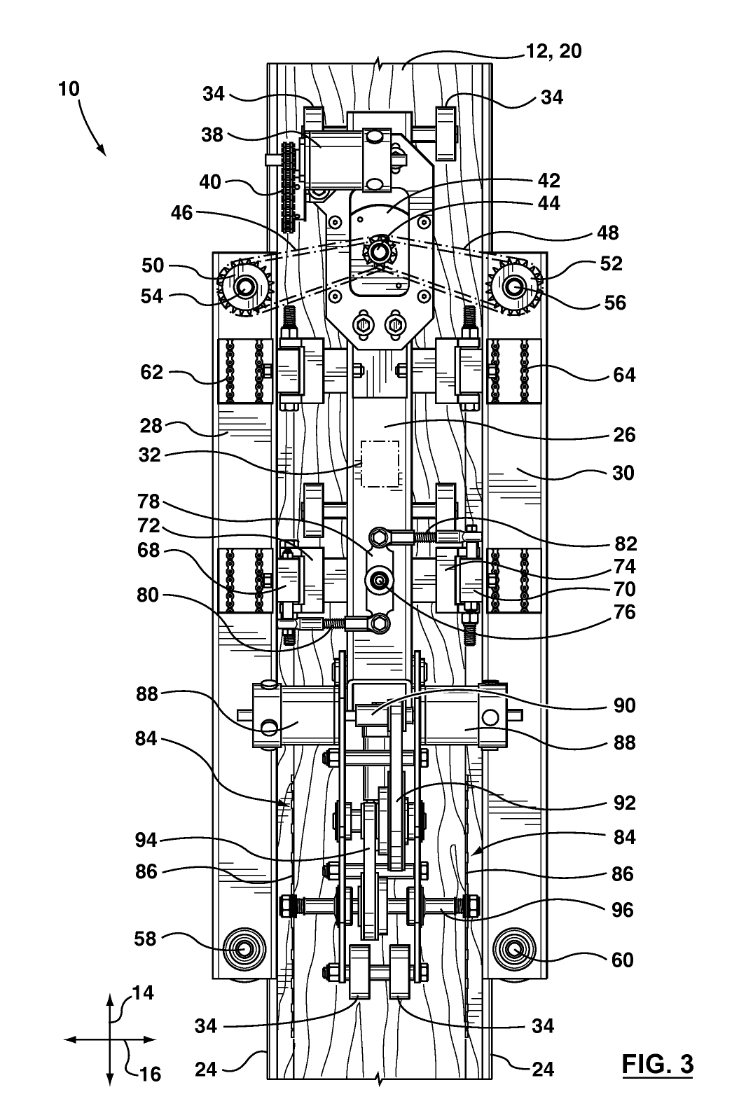

Referring to FIGS. 1, 2 and 3, an apparatus indicated generally by reference numeral 10 is configured to cut a guide post 12. The guide post 12 is typically formed of wood. The guide post 12 extends in a longitudinal or height direction 14, and has dimensions in both a lateral or width direction 16 and a depth direction 18. The guide post 12 includes an outer face 20, a first or left side face 22 and a second or right side face 24. The left and right side faces 22, 24 are in a generally opposing relationship. Typically, the outer face 20 is generally orthogonal to both of the left and right side faces 22, 24, but wear of the left and right side faces 22, 24 can result in a varied relationship between the faces 20, 22, 24.

The apparatus 10 can include a central frame member 26, and first and second side frame members 28, 30 coupled to the central frame member 26, and arranged on generally opposing sides thereof. Each of the frame members 26, 28, 30 can extend generally in the longitudinal direction 14. The frame members 26, 28, 30 can be formed of tubular material so that they are relatively lightweight and rigid. In some particular examples, the frame members 26, 28, 30 can be formed of tubular steel material having a square cross section. The central frame member 30 can include a surface 32 for mounting a spacer arm, which is described below.

At least one roller wheel 34 can be mounted to the central frame member 26. Each of the roller wheels 34 is configured to rollably support the central frame member 26 of the apparatus 10 along the outer face 20 of the guide post 12. At least one drive wheel 36 can be mounted to each of the side frame members 28, 30. Each of the drive wheels 36 is configured to rollably support the frame members 28, 30 of the apparatus 10 along the left and right side faces 22, 24, respectively.

In some examples, a drive motor 38 can be operably connected to each of the drive wheels 36. The drive motor 38 can drive a first drive chain 40 that connects to a gear box 42. The gear box 42 transfers mechanical power from the drive motor 38 to a central drive sprocket 44. Two lateral drive chains 46, 48 connect between the central drive sprocket 44 and left and right side sprockets 50, 52, respectively. The left and right side sprockets 50, 52 transfer mechanical power to left and right primary drive shafts 54, 56, respectively. The left and right primary drive shafts 54, 56 extend generally in the depth direction 18 and are coupled to the side frame members 28, 30, respectively.

Left and right secondary drive shafts 58, 60 are provided spaced apart from the left and right primary drive shafts 54, 56 in the longitudinal direction 14. The left and right secondary drive shafts 58, 60 also extend generally in the depth direction 18 and are coupled to the side frame members 28, 30, respectively. A longitudinal drive chain 62 connects between the left primary and secondary drive shafts 54, 58, and a longitudinal drive chain 64 connects between the right primary drive shafts 56, 60, so that mechanical power is transferred from the primary drive shafts 54, 56 to the secondary drive shafts 58, 60. The longitudinal drive chains 62, 64 can extend internally of the side frame members 28, 30, respectively.

The wheels 36 are fixed to ends of the drive shafts 54, 56, 58, 60. As illustrated, the drive wheels 36 can include teeth or other traction features for engaging and gripping the guide post 12.

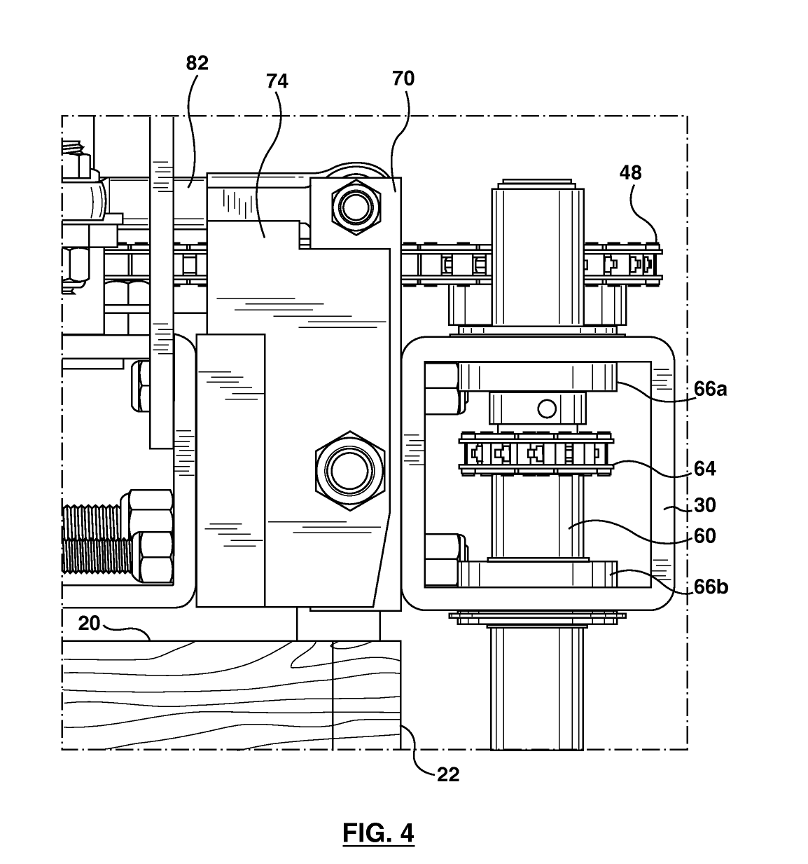

With particular reference to FIG. 4, each of the drive shafts 54, 56, 58, 60 can be coupled to the side frame members 28, 30 by means of upper and lower bearing units 66a, 66b. The bearing units 66a, 66b can be mounted directly to and within openings provided in the side frame members 28, 30. In some examples, the upper bearing unit 66a can be fixedly mounted to the respective side frame member 28, 30, whereas the lower bearing unit 66b can be mounted so that it is allowed a limited range of movement relative to the respective side frame member 28, 30. In some particular examples, the openings that receive the lower bearing units 66b can be slightly oblong in shape, having a greater dimension in the longitudinal direction 14 than in the lateral dimension 16. The bearing units 66b can therefore be free to move in the longitudinal direction 14 a limited extent, so that the respective drive shafts 54, 56, 58, 60 are offset slightly from parallel relative to the depth direction 18 when being driven. The limited offset means that, when driven along the guide post 12, the apparatus 10 will be biased generally in the depth direction 18 towards the guide post 12 so that there is generally continuous contact between the roller wheels 34 of the apparatus 10 and the outer face 20 of the guide post 12. All four of the drive shafts 54, 56, 58, 60 can be configured in this manner.

With continued reference to FIGS. 1, 2 and 3, the side frame members 28, 30 can be configured to be biased towards the central frame member 26 so that, when the apparatus 10 is positioned on the guide post 12, the drive wheels 36 bear against the faces 22, 24 of the guide post 12. In some examples, hinge blocks 68, 70 are fixed to the side frame members 28, 30, respectively, and complementary hinge blocks 72, 74 are fixed to the central frame member 26. The hinge blocks 68, 72 are pivotally connected to one another so that the side frame member 28 can pivot relative to the central frame member 26; the hinge blocks 70, 74 are pivotally connected to one another so that the side frame member 30 can pivot relative to the central frame member 26. The hinge blocks 68, 70 can be spring-loaded or otherwise biased relative to the hinge blocks 72, 74 so that the side frame members 28, 30 are urged towards one another.

In some particular examples, a pin 76 is mounted to the central frame member 26. An equalizer bar 78 is rotatably mounted on the pin 76. Biasing elements 80, 82 connect the hinge blocks 68, 70, respectively, to the equalizer bar 78. The equalizer bar 78 serves to balance force applied against the side faces 22, 24 of the guide post 12 by the wheels 36 by transferring force between the side frame members 28, 30.

The apparatus 10 includes at least one cutting mechanism 84. The cutting mechanism 84 can be mounted to the central frame member 26 frame and is configured to produce a cut in the guide post 12 along the outer face 20 substantially in the longitudinal direction 14 and substantially parallel to the side faces 22, 24. In the example illustrated, each of the cutting mechanisms 84 include a circular saw blade 86. The saw blades 86 are arranged generally parallel to the side faces 22, 24, offset in the lateral direction 16 from the side faces 22, 24 a distance corresponding generally to a desired thickness of material to be removed from the guide post.

At least one saw motor 88 is operably connected to each of the saw blades 86. In some examples, two of the saw motors 88 can be arranged to drive a common shaft 90. Pulleys 92, 94 can transfer mechanical power from the saw motors 88 to a common saw axle 96. The saw blades 86 can be fixed to opposite ends of the common saw axle 96.

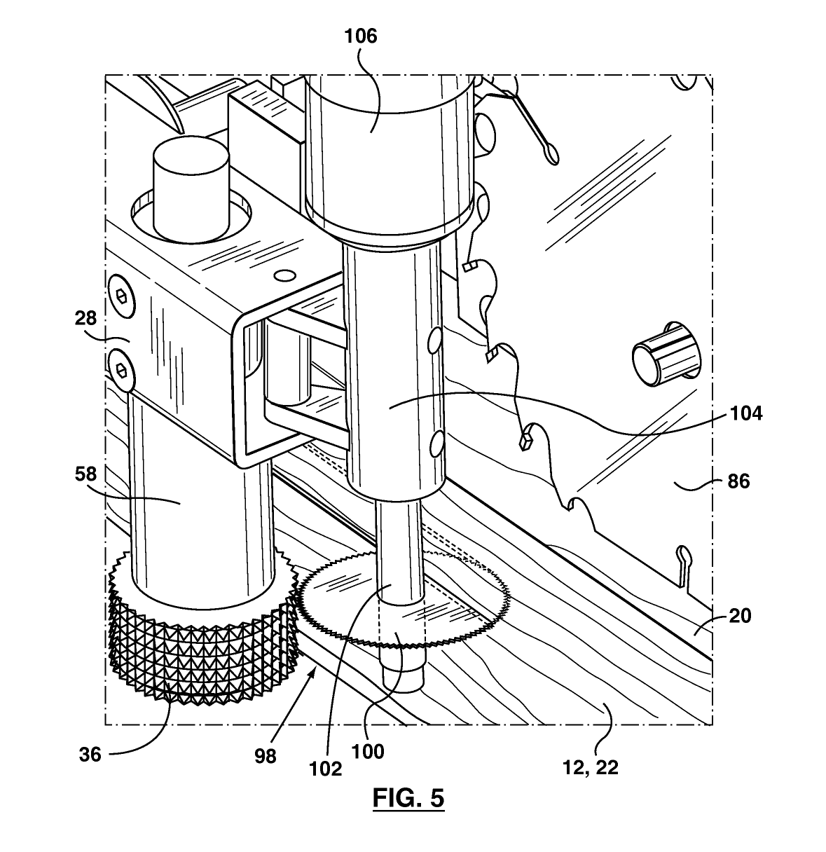

Referring to FIG. 5, the apparatus 10 can further include at least one side saw mechanism 98. As illustrated, the side saw mechanism 98 can be mounted to the side frame member 28, and is configured to produce a cut in the guide post 12 along the side face 22 substantially in the longitudinal direction 14 and substantially parallel to the outer face 20. The side saw mechanism can include a saw blade 100, a drive axle 102, a support bracket 104, and a motor 106. Similarly, a side saw mechanism (not shown) can be mounted to the side frame member 30, and be configured to produce a cut in the guide post 12 along the side face 24 substantially in the longitudinal direction 14 and substantially parallel to the outer face 20.

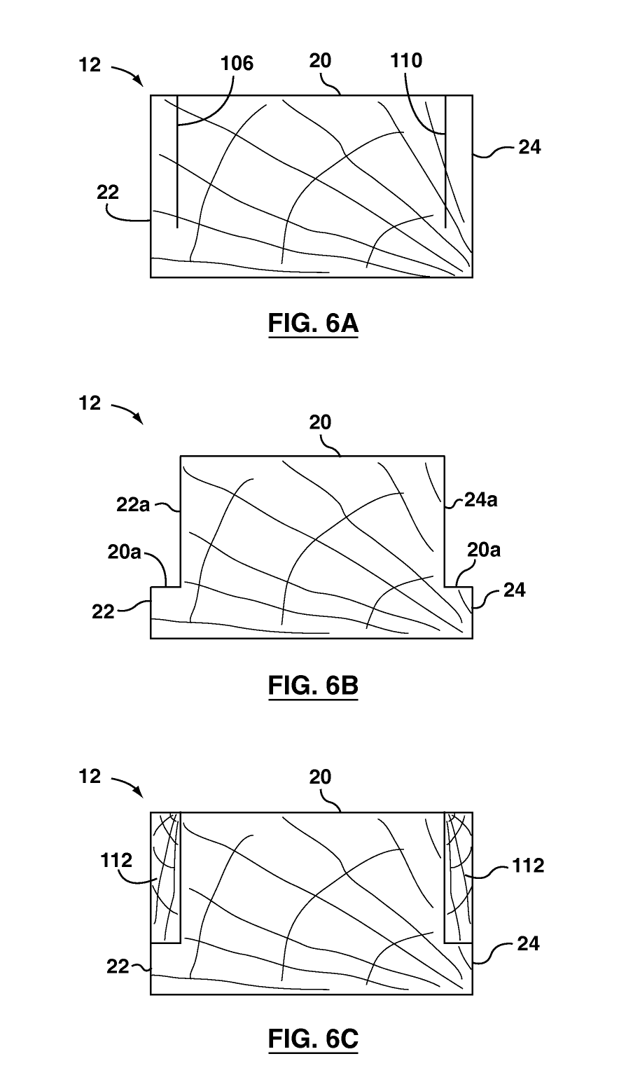

Referring to FIG. 6A, the apparatus 10 can be used to produce two cuts 108, 110 in the guide post 12 along the outer face 20 substantially parallel to the side faces 22, 24. Referring to FIG. 6B, material of the guide post 12 between the cuts 108, 110 and the side faces 22, 24 can be removed to expose new side faces 22a, 24a, respectively. Outer edge faces 20a bridge the distance between the side faces 22, 24 and new side faces 22a, 24a. Referring to FIG. 6C, replacement boards 112 can be provided and installed onto the new side faces 22a, 24a. The replacement boards 112 are sized and shaped so that, once installed, desired dimensions of the guide post 12 are formed. The replacement boards 112 can be installed or attached onto the new side faces 22a, 24a using, for example but not limited to, fasteners and/or adhesive. The replacement boards 112 can be formed of various materials, for example but not limited to, wood, plastic, metallic material, composite materials, etc.

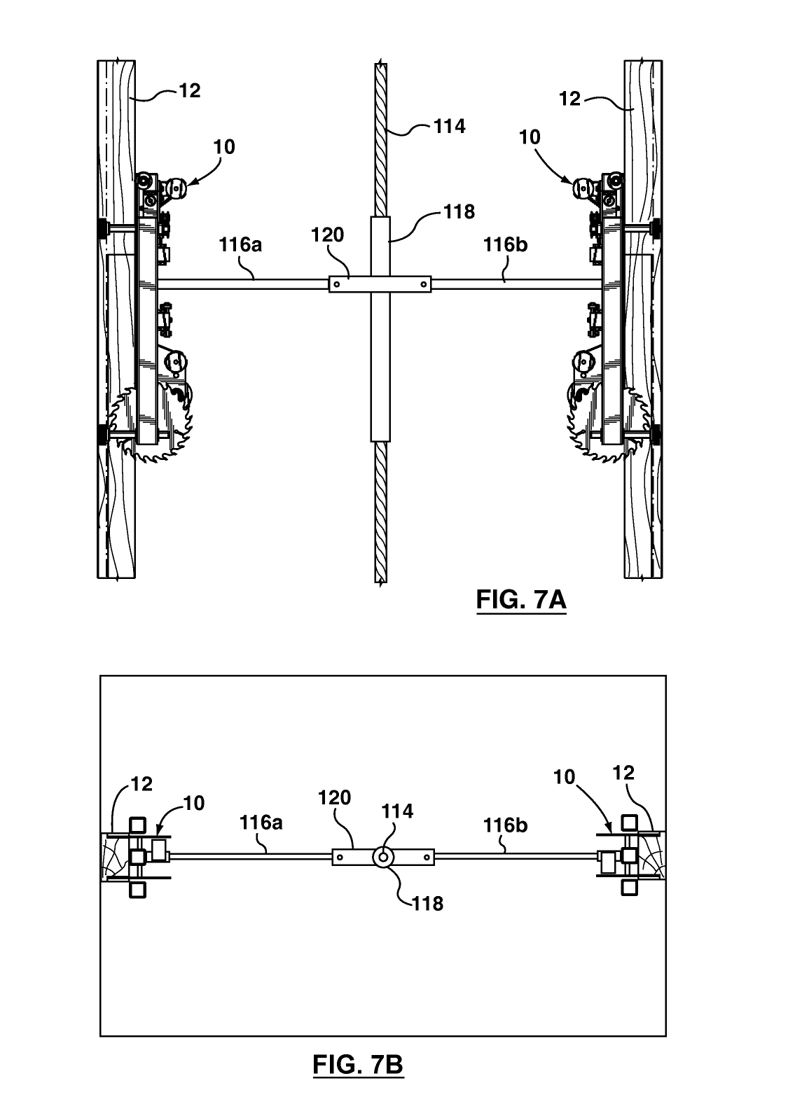

Referring to FIGS. 7A and 7B, in some mine shafts two guide posts 12 can be arranged opposing one another, and a guide rope 114 is provided extending generally in the middle of the shaft. Two of the apparatuses 10 can be arranged in generally opposing, mirror-image positions to make cuts in the two guide posts 12. The two apparatuses 10 can be connected by spacer arms 116a, 116b. A sleeve 118 can be provided to travel along the guide rope 114. The sleeve 118 includes a connecting portion 120 that is coupled to the spacing arms 116a, 116b. The connecting portion 120 can include biasing means for urging the spacer arms 116a, 116b away from one another so that each of the apparatuses bears against its respective one of the guide posts 12.

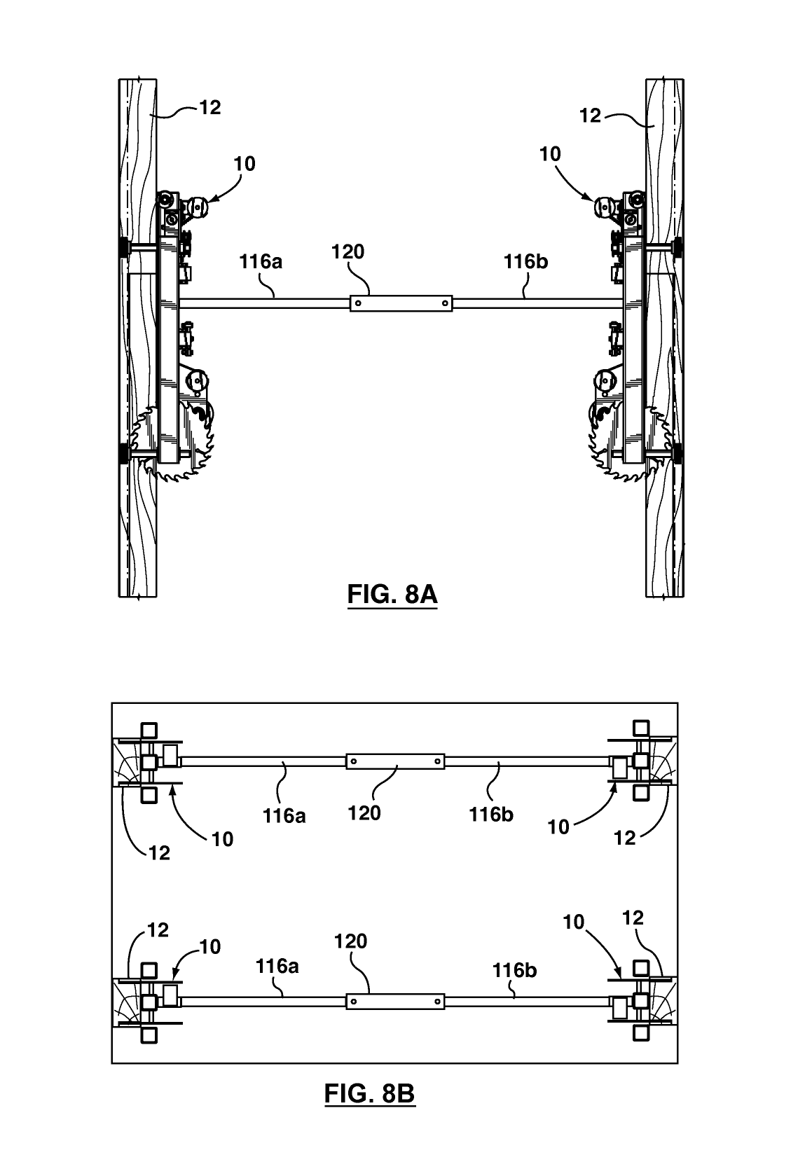

Referring to FIGS. 8A and 8B, in some mine shafts four guide posts 12 can be arranged in pairs opposing one another. Four of the apparatuses 10 can be arranged in positions to make cuts in the four guide posts 12. Each pair of the apparatuses 10 can be connected by spacer arms 116a, 116b. A connecting portion 120 couples the spacing arms 116a, 116b. The connecting portion 120 can include biasing means for urging the spacer arms 116a, 116b away from one another so that each of the apparatuses bears against its respective one of the guide posts 12.

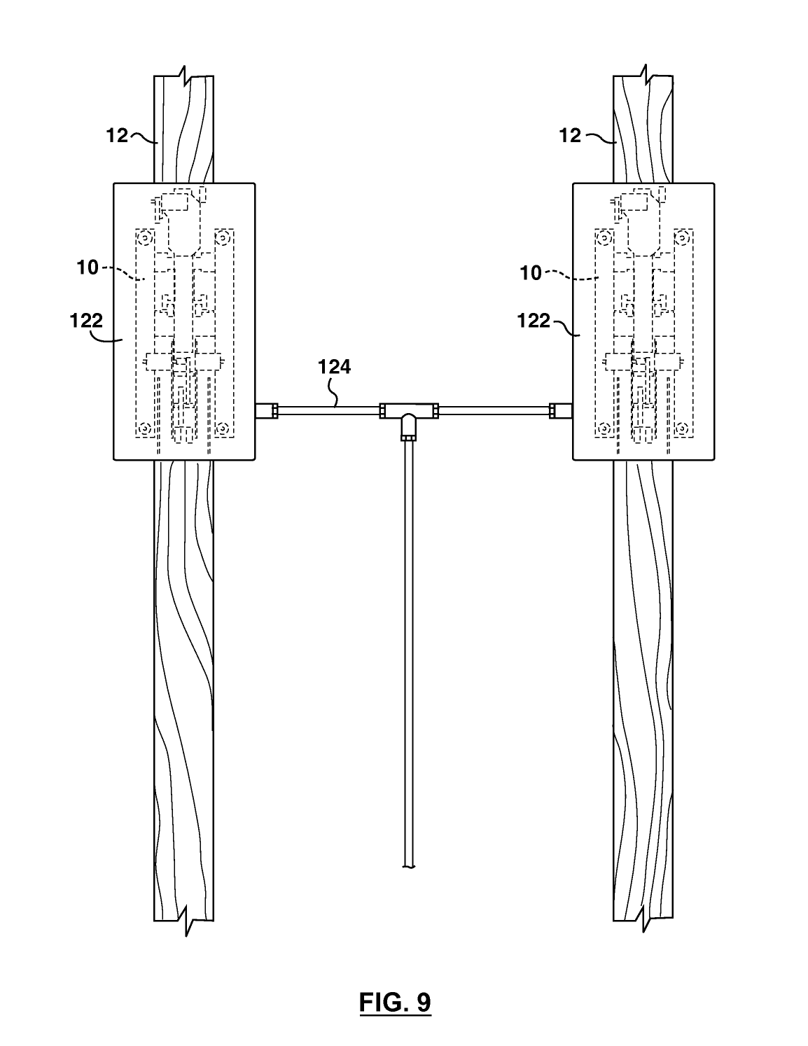

Referring to FIG. 9, the apparatuses 10 can be fitted with a cover 122. The covers 122 can be formed of clear plastic so that the apparatuses 10 can be at least partially visible underneath the covers 122. One or more of the covers 122 can be connected by vacuum hoses 124 enabling removal of sawdust away from around the apparatuses 10.

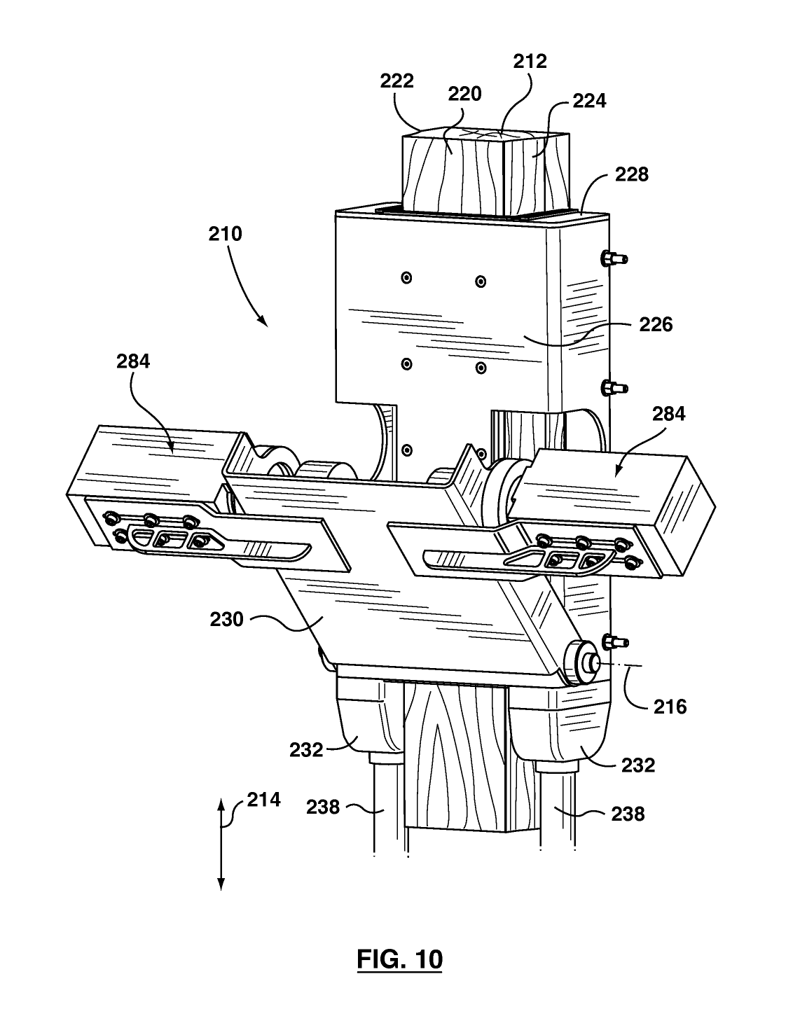

Referring to FIGS. 10, 11 and 12, another apparatus indicated generally by reference numeral 210 is configured to cut a guide post 212. The guide post 212 extends in a longitudinal or height direction 214, and includes side faces 222, 224 and an outer face 220. The side faces 222, 224 are shown with wear so that the side faces 222, 224 are not exactly orthogonal to the outer face 220.

The apparatus 210 includes a frame member 226, which can extend generally in the longitudinal direction 214 and around the guide post 212. The frame member 226 can be formed of plate or sheet steel or aluminum material, for example, so that it is relatively lightweight and rigid.

The frame member 226 may include a generally U-shaped top plate 228, which is sized and shaped to surround the guide post 212. The frame member 226 may further include a pivoting section 230, which is configured to pivot outwardly about a pivot axis 216 relative to the guide post 212. The frame member 226 may further include outlet ports 232, which may be coupled to vacuum hoses 238, enabling removal of sawdust collected within the frame member 226 during a cutting operation.

The apparatus 210 includes cutting mechanisms 284 mounted to the frame member 226. The cutting mechanisms 284 are configured to remove material from the side faces 222, 224 to expose new side faces (for example, generally as shown in FIG. 6B), thereby to enable replacement boards to be attached to the new side faces (for example, generally as shown in FIG. 6C).

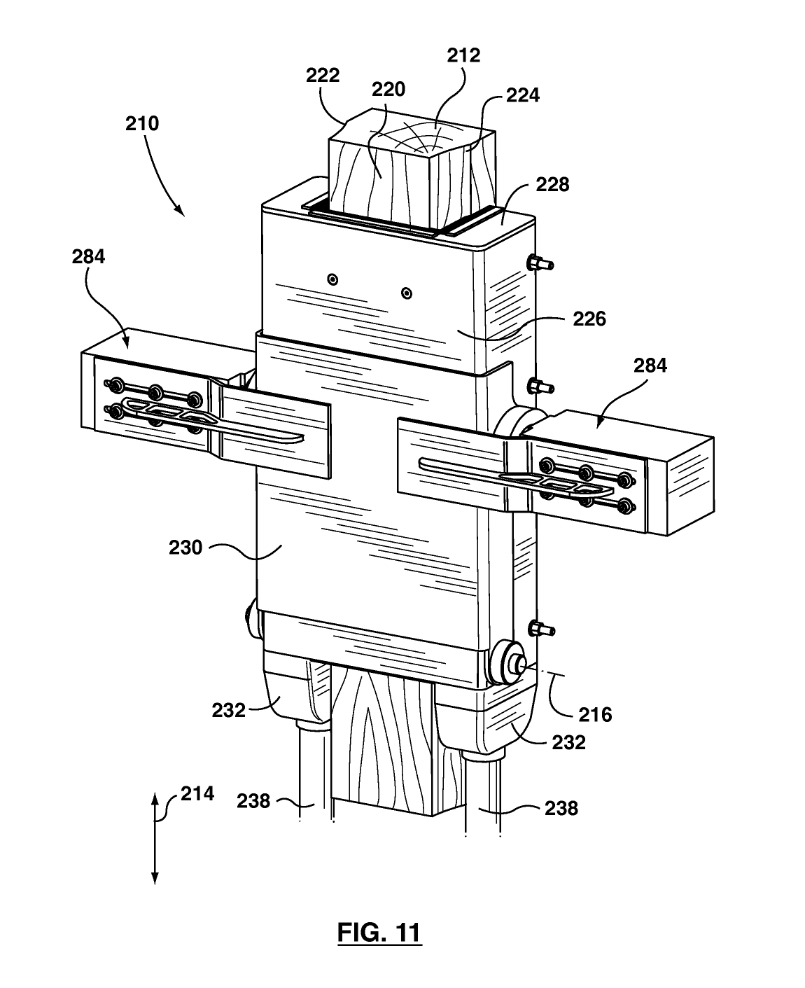

In the example illustrated, the cutting mechanisms 284 are mounted to the pivoting section 230 of the frame member 226, and are configured to pivot outwardly relative to the guide post 212 between an engaged position (see FIG. 11) in which the cutting mechanisms 284 are arranged to remove material from the side faces 222, 224, and a retracted position (see FIG. 10) in which the cutting mechanisms 284 are spaced apart from the guide post 212. Pivoting enables the apparatus 210 to be first positioned on the guide post 212 before engaging the cutting mechanisms 284. In the engaged position, the cutting mechanisms 284 are arranged in generally opposing alignment on either side of the guide post 212. The apparatus 210 may further include an locking mechanism (not shown) for locking the pivoting section 230 in the engaged and/or retracted positions relative to the rest of the frame member 226.

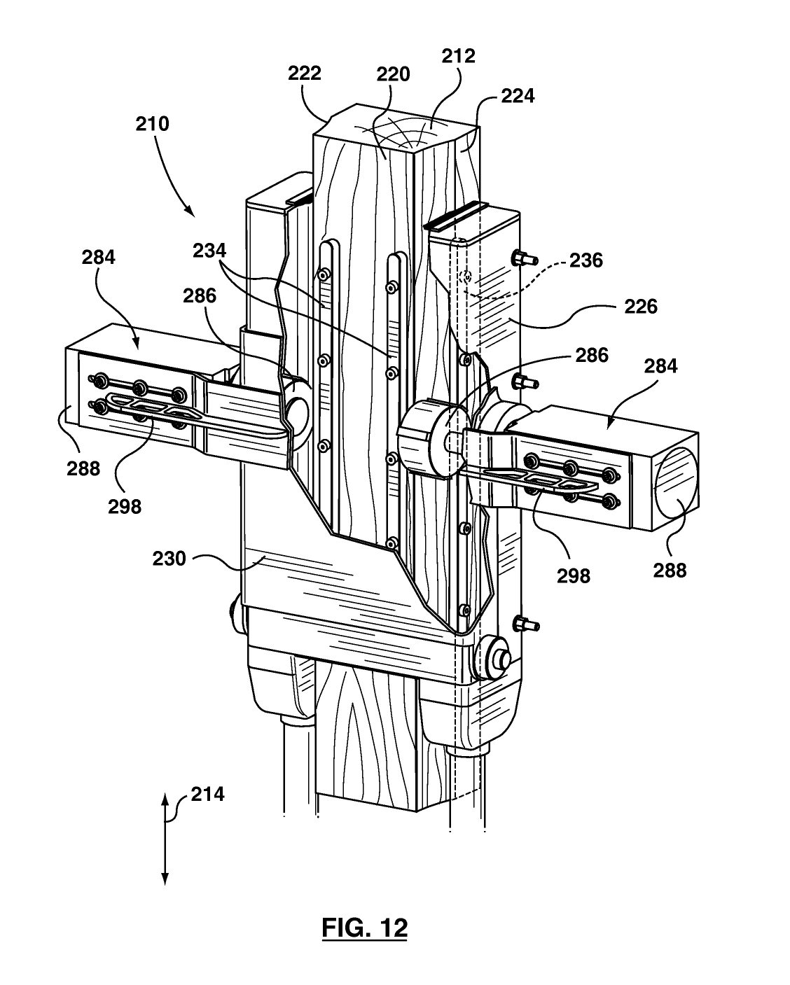

In the example illustrated, referring particularly to FIG. 12, each of the cutting mechanisms 284 include a spindle motor 288 and a rotary bit 286 driven by the spindle motor 288. The bits 286 may be arranged generally perpendicular to the side faces 222, 224, and offset inwardly from the side faces 222, 224 to a cutting depth corresponding generally to a desired thickness of material to be removed from the side faces 222, 224.

The apparatus 210 further includes a guide device mounted to or within the frame member 126 configured to guide the apparatus 210 along the guide post 212 and enable the apparatus 210 to travel along the guide post 212. In the example illustrated, with continued reference to FIG. 12, the guide device may take the form of at least one outer slider rail 234 configured to travel along the outer face 220 of the guide post 212, and/or at least one side slider rail 236 configured to travel along side faces 222, 224 of the guide post 212. The rails 234, 236 can be formed of a material having a relatively low coefficient of friction, for example, UHMW polyethylene.

The apparatus 210 may be manually guided by an operator along the guide post 212, for example using handles 298, curing a cutting operation. The apparatus 210 can be used to remove material from at least one of the side faces 222, 224 of the guide post 212 to expose at least one new side face, thereby to enable replacement boards to be installed onto the new side faces, as described above. The replacement boards may be sized and shaped so that, once installed, desired dimensions of the guide post 212 are formed. The replacement boards can be installed or attached onto the new side faces using, for example but not limited to, fasteners and/or adhesive. The replacement boards can be formed of various materials, for example but not limited to, wood, plastic, metallic material, composite materials, etc.

While the above description provides examples of one or more processes or apparatuses, it will be appreciated that other processes or apparatuses may be within the scope of the accompanying claims.

We claim:

1. An apparatus for refurbishing a guide post, the guide post extending in a longitudinal direction and including a first side face and an outer face, the apparatus comprising:
a frame;
a plurality of wheels mounted to the frame and configured to rollably support the apparatus along the guide post; and
a first cutting mechanism mounted to the frame and configured to produce a cut in the guide post along the outer face substantially in the longitudinal direction and substantially parallel to and adjacent the first side face.

2. The apparatus as claimed in claim 1, further comprising a second cutting mechanism mounted to the frame and configured to produce a cut in the guide post along the outer face substantially in the longitudinal direction and substantially parallel to and adjacent a second side face of the guide post generally opposing the first side face.

3. The apparatus as claimed in claim 2, wherein the plurality of wheels comprise at least one roller wheel mounted to the frame and configured to rollably support the apparatus along the outer face of the guide post.

4. The apparatus as claimed in claim 3, wherein the plurality of wheels comprise drive wheels mounted to the frame and configured to drive the apparatus along the first and second side faces.

5. The apparatus as claimed in claim 4, wherein the drive wheels are operably connected to a central drive sprocket.

6. The apparatus as claimed in claim 4, wherein the drive wheels include traction features for engaging and gripping the guide post.

7. The apparatus as claimed in claim 4, wherein, when the drive wheels are driven along the guide post, the apparatus is biased generally towards the guide post.

8. The apparatus as claimed in claim 4, wherein the frame comprises a central frame member and first and second side frame members coupled to the central frame member and arranged on generally opposing sides thereof, the first cutting mechanism mounted to the first side frame member and the second cutting mechanism mounted to the second side frame member.

9. The apparatus as claimed in claim 8, wherein the drive wheels comprise drive wheels mounted to the first side frame member configured to drive the apparatus along the first side face, and drive wheels mounted to the second side frame member configured to drive the apparatus along the second side face.

10. The apparatus as claimed in claim 9, wherein the first and second side frame members are biased towards the central frame member so that, when positioned on the guide post, the drive wheels bear against the first and second side faces.

11. The apparatus as claimed in claim 10, further comprising means for transferring force between the first and second side frame members to generally balance force applied against the first and second side faces by the drive wheels.

12. The apparatus as claimed in claim 2, wherein each of the first and second cutting mechanisms comprise a circular saw blade.

13. The apparatus as claimed in claim 12, wherein the circular saw blades are operably connected to a common saw axle.

14. The apparatus as claimed in claim 2, further comprising side saw mechanisms mounted to the frame for cutting the guide post along the first and second side faces substantially in the longitudinal direction, whereby the cuts in the guide posts enable material to be removed from the guide post.

15. A method of refurbishing a guide post, the guide post extending in a longitudinal direction and including a first side face and an outer face, the method comprising:
producing a first cut in the guide post along the outer face substantially in the longitudinal direction and substantially parallel to and adjacent the first side face;
removing material of the guide post between the first cut and the first side face to expose a new first side face; and
installing at least one replacement board onto the new first side face, the at least one replacement board being sized and shaped so that desired dimensions of the guide post are formed.

16. The method as claimed in claim 15, applied to a guide post having a second side face generally opposing the first side face, the method further comprising:
producing a second cut in the guide post along the outer face substantially in the longitudinal direction and substantially parallel to and adjacent the second side face;
removing material from the guide post between the second cut and the second side face to expose a new second side face; and
installing at least one replacement board onto the new second side face, the replacement board being sized and shaped so that the desired dimensions in the guide post are formed.

17. The method as claimed in claim 16, comprising providing wooden replacement boards as the replacement boards.

18. The method as claimed in claim 16, comprising providing replacement boards formed of plastic material, metallic material, or a composite material.

19. An apparatus for refurbishing a guide post, the guide post extending in longitudinal direction and including side faces and an outer face, the apparatus comprising:
a frame;
a guide device mounted to the frame and configured to guide the apparatus along the guide post and enable the apparatus to travel along the guide post; and
a cutting mechanism mounted to the frame and configured to remove material from at least one of the side faces to expose at least one new side face, thereby to enable at least one replacement board to be attached to the at least one new side face.

20. The apparatus as claimed in claim 19, wherein the cutting mechanism comprises first and second cutting mechanisms, each of the first and second cutting mechanisms configured to remove material from a respective one of the side faces to expose new side faces.

21. The apparatus as claimed in claim 20, wherein the cutting mechanisms are configured to pivot outwardly relative to the guide post between an engaged position in which the cutting mechanism is arranged to remove material from the respective side face and a retracted position in which the cutting mechanisms are spaced apart from the guide post.

22. The apparatus as claimed in claim 21, wherein, in the engaged position, the first and second cutting mechanisms are arranged in generally opposing alignment on either side of the guide post.

23. The apparatus as claimed in claim 20, wherein each of the first and second cutting mechanisms comprise a spindle motor and a bit driven by the spindle motor.

24. The apparatus as claimed in claim 19, wherein the guide device comprises at least one outer slider rail configured to travel along the outer face.

25. The apparatus as claimed in claim 24, wherein the guide device comprises at least one side slider rail configured to travel along each of the side faces.

26. A method of refurbishing a guide post, the guide post extending in a longitudinal direction and including side faces and an outer face, the method comprising:
removing material from the guide post along at least one of the side faces to expose at least one new side face; and
installing at least one replacement board to the at least one new side face, the at least one replacement board being sized and shaped so that desired dimensions of the guide post are formed.

27. The method as claimed in claim 26, comprising removing material from both side faces, exposing respective new side faces, and installing a plurality of the replacement boards to the new side faces.

28. The method as claimed in claim 27, comprising providing wooden replacement boards as the replacement boards.

29. The method as claimed in claim 27, comprising providing replacement boards formed of plastic material, metallic material, or a composite material.

30. The method as claimed in claim 26, wherein the step of removing comprises manually guiding an apparatus along the guide post, the apparatus comprising at least one cutting mechanism for removing material from the guide post.
